(19) United States
(12) Patent Application Publication
(10) Pub. No.: US 2018/0089660 A1
(43) Pub. Date: Mar. 29, 2018

(54) MAKING ANONYMOUS PAYMENTS

(71) Applicant: APPLE INC., Cupertino, CA (US)

(72) Inventors: Thomas ELLIOTT, Redwood City, CA (US); Timothy S. HURLEY, Los Gatos, CA (US); Richard M. KRAKOWSKI, La Selva Beach, CA (US); Richard D. EWING, San Francisco, CA (US); Glen W. STEELE, San Jose, CA (US); Rupa B. VAZIRANI, Menlo Park, CA (US)

(21) Appl. No.: 15/627,285

(22) Filed: Jun. 19, 2017

Related U.S. Application Data
(60) Provisional application No. 62/399,278, filed on Sep. 23, 2016.

(51) Int. Cl. G06Q 20/32; G06Q 20/22

(52) U.S. Cl. CPC G06Q 20/322; G06Q 20/223

(57) ABSTRACT

The systems and methods disclosed herein provide features that allow a user (e.g., sender) to make anonymous direct person-to-person payments to a recipient (e.g., another user). In some cases, the recipient may be someone that the sender of the payment does not know. Thus, the sender and/or recipient of the payment may wish to obfuscate (e.g., hide, obscure, etc.) at least a portion their respective identities. The sender and/or recipient can configure the system to provide a limited amount (e.g., some, or none) of personal information to the other party to the transaction. When the system processes the transaction, the configured amount of personal information can be shared with each party (e.g., sender, recipient) to the transaction so that each party can maintain a desired level of anonymity.

### CROSS-REFERENCE TO RELATED APPLICATIONS

This application claims priority to U.S. Provisional Application No. 62/399,278, filed on Sep. 23, 2016, the content of which is incorporated herein by reference in its entirety.

### TECHNICAL FIELD

This disclosure generally relates to wireless communication, and more specifically to techniques for conducting financial transactions by using mobile devices.

### BACKGROUND

Modern day commerce involves conducting financial transactions through many different channels using a variety of instruments. There is presently increasing interest in using mobile devices to conduct financial transactions. Under some circumstances, payment for services (e.g., tipping someone the user does not know), goods (e.g., buying something from craigslist), or sharing cost (e.g., sharing the dinner cost with some people you do not know) typically involves the user paying cash because it can be difficult for the user (e.g., payment sender) to conduct financial transactions directly with the recipient using their mobile devices. However, if two individuals (e.g., strangers) attempt to directly conduct a financial transaction, they may have to disclose their personal and/or financial information to each other, which may discourage them from using their mobile devices to conduct the financial transaction. Thus, an improved mechanism for creating an easy and efficient way for the sender to tip or pay a recipient (e.g., valet) without disclosing their personal information (e.g., sender and/or recipient) or by only disclosing limited personal information to each other based on their own preference is needed.

### SUMMARY

The systems and methods disclosed herein provide features that allow a user (e.g., sender) to make anonymous direct person-to-person payments to a recipient (e.g., another user). In some cases, the recipient may be someone that the sender of the payment does not know. Thus, the sender and/or recipient of the payment may wish to obfuscate (e.g., hide, obscure, etc.) at least a portion of their respective identities. The sender and/or recipient can configure the system to provide a limited amount (e.g., some, or none) of personal information to the other party to the transaction. When the system processes the transaction, the configured amount of personal information can be shared with each party (e.g., sender, recipient) to the transaction so that each party can maintain a desired level of anonymity.

Particular implementations may provide at least the following advantages, which are not a required feature of any embodiment. A user (e.g., the sender) can make simple and fast anonymous direct person-to-person payments to a recipient by using user's mobile phone to obtain recipient's payment token. This way, the user does not need to know who the recipient is and does not need to input any recipient's information to complete the payment transaction.

Details of one or more implementations are set forth in the accompanying drawings and the description below. Other features, aspects, and potential advantages will be apparent from the description and drawings, and from the claims.

### DESCRIPTION OF DRAWINGS

FIG. 1 is a block diagram of an example system for making anonymous payments.

FIG. 2 is a block diagram of an example system for providing candidate recipient notifications for making anonymous payments.

FIG. 3 illustrates an example graphical user interface displaying payment transaction options.

FIG. 4 illustrates an example graphical user interface displaying payment options to the sender.

FIG. 5 is a block diagram of an example system for transferring the final payment amount from the sender to the recipient.

FIG. 6 illustrates an example graphical user interface for displaying payment confirmation notification.

FIG. 7 is a flow diagram of an example process for making anonymous payments.

FIG. 8 is a block diagram of an example system architecture implementing the features and processes of FIGS. 1-7.

Like reference symbols in the various drawings indicate like elements.

### DETAILED DESCRIPTION

### Overview

Examples of a method, apparatus, and computer program for making anonymous payments are disclosed below. In the following description, for the purposes of providing explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

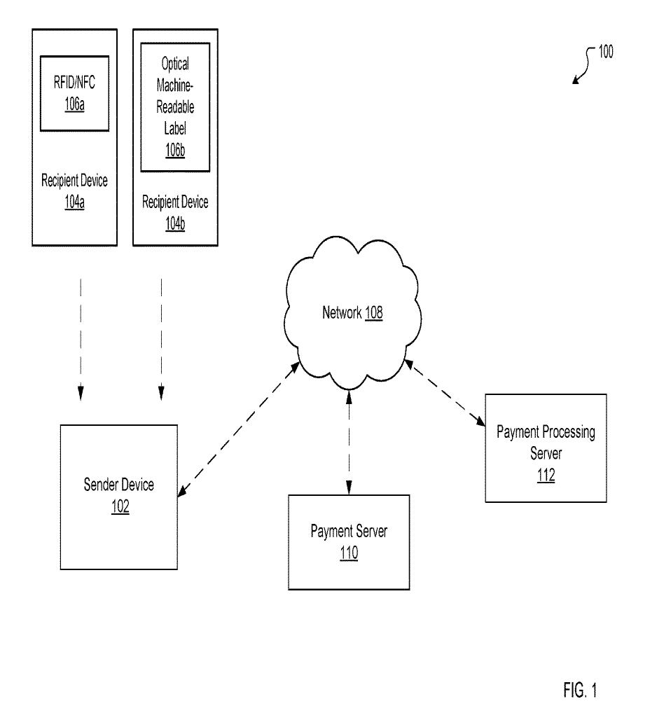

FIG. 1 is a block diagram of an example system for making anonymous payments. For example, system 100 can be configured to perform a person-to-person transaction between parties (e.g., a payment sender and a payment recipient) to the transaction while obfuscating at least a portion of the parties' personal information. For example, the personal information can include an image of the party, an identifier (e.g., name) of the party, contact information for the party, and/or other personal information, as may be described herein.

To enable person-to-person payments, a user (e.g., payment sender, payment recipient) can register traditional payment account information with a payment processing server. For example, the user can create a device payment account with a payment processing server and associate the device payment account with a payment token (e.g., an email address, telephone number, other user identifier, etc.). The user can provide traditional payment account information to the payment processing server and associate the traditional payment account information with the device payment account. For example, the traditional payment account information can include account numbers, authentication credentials, the user's name, user's address, and/or other information associated with credit card accounts, debit card accounts, checking accounts, etc. The user can then provide the payment token to other users or receive the payment token from other users when performing a person-to-person transaction (e.g., payment). For example, a payment recipient's device can provide the recipient's payment token to a payment sender's device. The payment sender's device can then provide both the recipient's payment token and the sender's payment token to the payment processing server so that the payment processing server can process a transaction transferring money from a traditional payment account associated with the payment sender's device payment account (e.g., identified by the sender's payment token) to a traditional payment account associated with the payment recipient's device payment account (e.g., identified by the recipient's payment token).

In some implementations, the user (e.g., sender, recipient, etc.) can configure a device payment account (e.g., sender's account, recipient's account, etc.) to provide anonymous information (e.g., to obfuscate at least a portion of sender's personal information or identity) to the recipient. For example, a payment token (e.g., sender's token, recipient's token, etc.) can be an email address, a telephone number, a picture of the recipient, etc.

In some implementations, system 100 can include sender device 102. For example, sender device 102 can be a computing device, such as a smartphone, tablet computer, laptop computer, electronic book device, game device, smart watch, smart glasses and/or other mobile or wearable device, the accessories and peripherals of these devices, or any combination thereof.

In some implementations, sender device 102 may include a near field communication (NFC) interface. For example, the NFC interface may identify and allow for close range communication at relatively low data rates (424 kb/s), or it may allow for close range communication at relatively high data rates (560 Mbps). The close range communication with the NFC interface may take place through magnetic field induction, allowing the NFC interface to communicate with other NFC devices such as radio frequency identification (RFID) tags, for example. In some implementations, the NFC interface may be used to identify a recipient associated with recipient's device that contains an NFC compatible device such as an RFID tag.

In some implementations, system 100 can include a recipient identification device. For example, the recipient identification device can correspond to the recipient mobile device when the mobile device is broadcasting or sending the recipient payment token (e.g., recipient identifier). In some implementations, the recipient identification device can be a wireless access point (Wi-Fi) that transmits recipient's payment token (e.g., at a business, restaurant, etc.).

In some implementations, system 100 can include recipient identification device 104a/104b. For example, recipient identification device 104a/104b can correspond to a QR label, NFC chip/RFID embedded in an identification card, name tag, etc. that can be scanned by a payment sender's device to obtain a recipient payment token.

In some implementations, sender device 102 can receive the recipient payment token when sender device 102 is within range of the recipient identification device. The range can vary based on which technology is used to receive the recipient payment token.

For example, the recipient mobile device 104a can advertise the recipient payment token and/or the ability for the recipient to receive a payment. For example, the recipient mobile device can send sender device 102 a recipient payment token through peer-to-peer Wi-Fi, Bluetooth, etc. For example, the recipient mobile device can advertise a recipient payment token (e.g., recipient's phone number, recipient's email, recipient's account, etc.) including an identifier for recipient's payment account registered with a payment processing server.

In some implementations, sender device 102 may receive multiple recipient payment tokens from multiple recipient identification devices. In some implementations, the sender can then select one of the received payment tokens (i.e., candidate recipient notifications) to continue the process of the payment transaction.

For example, when sender device 102 obtains the recipient payment token from recipient identification device 104a, sender device 102 will then move into the payment mode. For example, upon receiving the recipient payment token, sender device can display a candidate recipient notification including the recipient token (e.g., recipient's phone number, recipient's email, recipient's account, etc.) on sender device 102. Alternatively, for example, upon receiving the recipient payment token from recipient identification device 104a, sender device 102 can send a transaction package including the received recipient payment token from recipient identification device 104a and the sender payment token of sender device 102 through network 108 to a payment server. Later, sender device 102 can receive a candidate recipient notification including the additional recipient anonymous information (e.g., a picture of the recipient, recipient's alias) from the payment server. In some implementations, sender device 102 can display a candidate recipient notification including the additional recipient anonymous information (e.g., a picture of the recipient, recipient's alias) on sender device 102.

In some implementations, system 100 can include payment server 110. For example, payment server 110 can receive a transaction package, described above, from sender device 102 through network 108. In some implementations, payment server 110 can determine if the recipient has registered with payment server 110 based on the data in the transaction package. For example, payment server 110 can determine if recipient's tokens identify recipient's accounts that are registered with the payment processing server. In some implementations, payment server 110 can determine if the sender has registered with payment server 110 based on the data in the transaction package. For example, payment server 110 can determine if sender's tokens identify accounts that are registered with payment processing server 112. For example, the recipient payment token can include a picture of the recipient, recipient's nickname or alias, recipient's employee number, etc. based on the preference of the recipient.

In some implementations, system 100 can include payment processing server 112. For example, payment processing server 112 can receive sender authentication credentials from sender device 102 through network 108. For example, the sender authentication credentials can include the sender payment token, the recipient payment token, the final payment amount, sender's biometric data, fingerprint etc. In some implementations, payment processing server 112 can validate the sender is authorized for the payment account based on sender authentication credentials provided by sender device 102.

In some implementations, payment processing server 112 can determine whether the payment should be transferred from sender's account to recipient's account based on sender authentication credentials provided by sender device 102. For example, once the sender authentication credentials are validated, payment processing server 112 can send a payment confirmation notification to sender device 102 indicating that payment was processed.

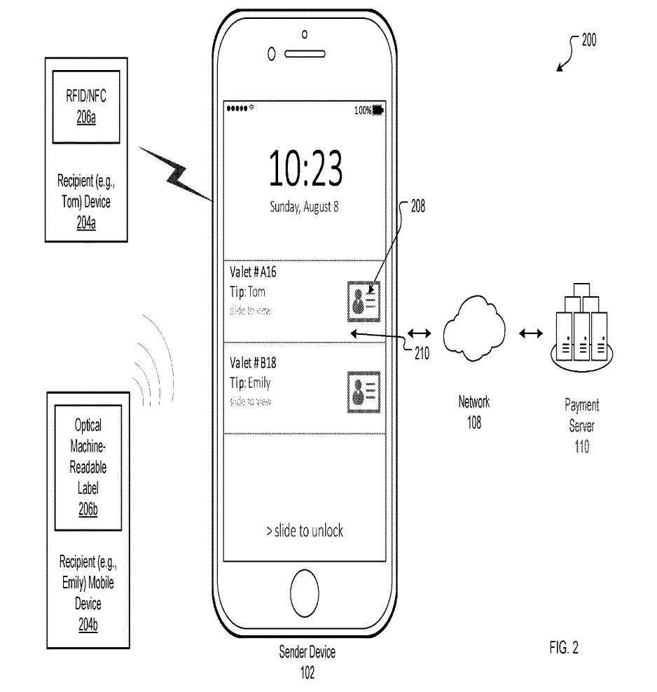

FIG. 2 is a block diagram of system 200 for providing candidate recipient notifications. For example, system 200 can correspond to system 100 of FIG. 1. System 200 can, for example, obtain recipient's payment token from different recipient identification devices. In some implementations, system 200 can then send the transaction package including the received recipient payment token and the sender payment token to payment server 110 through network 108. In some implementations, upon receiving the transaction package, payment server 110 can provide additional recipient's anonymous information (e.g., to obfuscate at least a portion of recipient's personal information or identity) associated with the recipient token. In some implementations, additional recipient's anonymous information may include email address, a telephone number, a picture of the recipient, etc. In some implementations, payment server 110 can send the additional recipient anonymous information associated with recipient payment token to sender device 102.

In some implementations, sender device 102 may receive multiple candidate recipient notifications associated with anonymous information from more than one recipient. In some implementations, the candidate recipient notification can include the information about the potential recipient. For example, upon receiving multiple candidate recipient notifications, sender device 102 can present those candidate recipient notifications including their additional recipient's anonymous information to the user. In some implementations, sender device 102 may receive and present multiple candidate recipient notifications at same time. Thus, the sender may process the payment to the particular recipient by selecting (e.g., slide to view, click the notification etc.) the corresponding candidate recipient notification. In some implementations, the graphical user interface of sender device 102 can display the graphical candidate recipient notification 210 on the sender device 102 display screen. For example, the graphical user interface can be a home screen, navigational menu, or application selection user interface. For example, graphical element 208 can be an image, icon, or other graphical objects for a user to select to initiate the anonymous payment.

In some implementations, system 200 can perform payment transactions over a short range communication interface according to some embodiments of the present technology. In some implementations, the recipient mobile devices may broadcast the recipient payment tokens. In some implementations, sender device 102 can obtain the recipient payment token from recipient identification device 204a. In some implementations, sender device 102 can only receive the recipient payment token when it is within the range of recipient identification device 104a. Thus, in some implementations, the user may move sender device 102 near recipient identification device 104a to receive the recipient payment token and initiate a transaction. In some implementations, in response to receiving the recipient payment token, sender device 102 may automatically present the recipient identifier or recipient payment token (e.g., recipient's alias, recipient's employee number, etc.) in the candidate recipient notification to the sender.

Alternatively, in response to receiving the recipient payment token, sender device 102 may send the transaction package including the recipient payment token and the sender payment token to payment server 110. In some implementations, as described above, upon receiving the additional recipient anonymous information from payment server 110, sender device 102 may display the recipient identifier or additional recipient's anonymous information based on the recipient's preference to the sender. In some implementations, sender device 102 can only receive the recipient payment token when it is within the range of recipient identification device 204a. Thus, the user may move user device 102 near recipient identification device 204a to receive the recipient payment token. In some implementations, the user may provide authentication credentials (e.g., biometric data, fingerprint). For example, when credentials are validated, sender device 102 can send payment account information to payment process server 112. In some implementations, sender device 102 can dismiss candidate recipient notifications.

For example, the process described above may begin with initiating a payment transaction by initiating a short range communication session between sender device 102 and recipient identification device 204a. For example, by bringing sender device 102 within electronic communication range of recipient identification device 204a, sender device 102 can initiate payment transactions to exchange the device information and information about the recipient.

In some implementations, bringing the sender device 102 within communication range includes moving the sender device 102 within a physical proximity such that electronic communications over a short range communications channel, such as NFC, can be established. In some implementations, bringing the sender device 102 within communication range involves tapping sender device 102 on recipient identification device 204a. In some implementations, bringing sender device 102 within communication range of the recipient identification devices involves a close proximity, but does not require contact by the devices.

In some implementations, as described above, candidate recipient notification 210 can include recipient's anonymous information associated with recipient's payment token for the sender to identify the recipient. For example, recipient's anonymous information can include picture 208 of recipient, recipient's nickname or alias (e.g., Tom), recipient's employee number (e.g., A16), etc. based on the preference of the recipient. In some implementations, the recipient can set up or change the preference with payment server 110 as described above. For example, if a valet wants to receive a tip from a sender, the valet can provide his/her picture to payment server 110 to assist the sender in recognizing them. Alternatively the valet can provide his/her alias to the payment server 110.

In some implementations, sender device 102 can obtain recipient tokens through RFID, NFC, QR-Code etc. as described above. For example, user device 102 may obtain recipient's payment token from radio frequency identification (RFID) label 206a of recipient identification device 204a by using electromagnetic fields. In some implementations, sender device 102 can obtain recipient payment token by scanning the QR code 206b of recipient identification device 204b. As described above, in some implementations, after receiving the recipient payment tokens, sender device 102 can send the transaction package including the received recipient payment token and the sender payment token to payment server 110 through network 108.

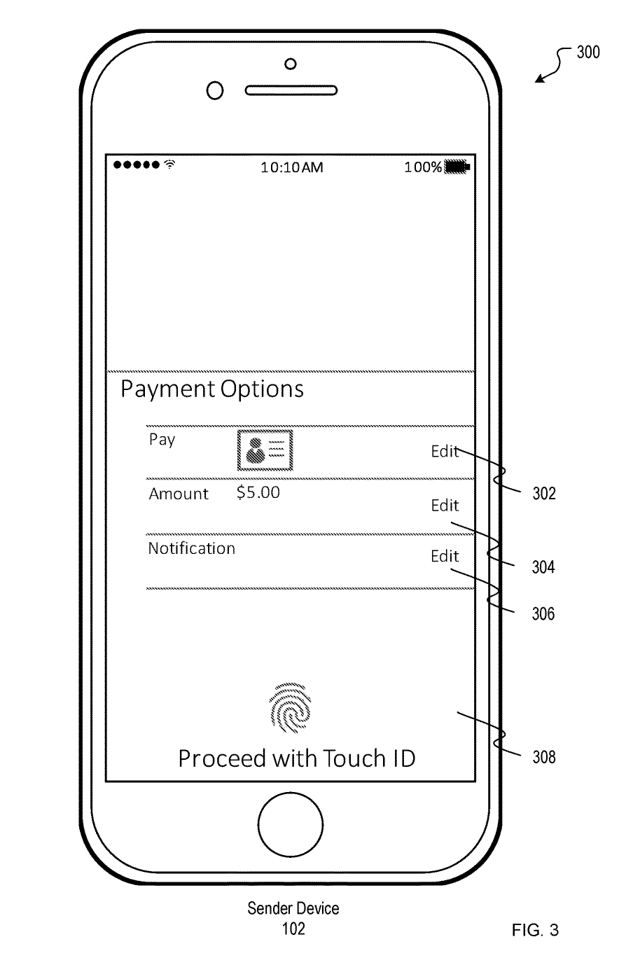

FIG. 3 illustrates an example graphical user interface 300 displaying payment transaction options. To facilitate the following discussion regarding the operation of sender device 102 in conducting a payment transaction, reference is made to drawings which may be representative of possible screen shots of sender device 102 during the transaction. The functionality described may be achieved with a wide variety of graphical elements and visual schemes. Therefore, the present embodiments are not intended to be limited to the precise user interface conventions adopted herein. Rather, embodiments may include a wide variety of user interface styles.

For example, as described above, the sender may initiate processing of the payment to the particular recipient by selecting (e.g., slide to view, click the notification etc.) the payment transaction candidate option corresponding to the particular recipient. In some implementations, upon receiving the selection by the sender, sender device 102 can present payment transaction detail options to the sender. In some implementations, the payment transaction detail options may include recipient anonymous ID 302, payment amount 304, and/or notification 306 for the limited sender's personal information settings. For example, the sender can change the recipient to pay by selecting or clicking graphical element 302. For example, from the payment transaction options screen 300, the user may select a default payment amount or the user may provide input to select other payment amount. For example, the sender can change the payment amount from the default amount set by sender device 102 or the sender by selecting or clicking graphical element 304. For example, the sender can change the notification regarding the limited sender's personal information about the sender from the default setting by sender device 102 or the sender by selecting or clicking graphical element 306. For example, if the sender wants the recipient to know who sent the money to the recipient by sender's alias, the sender may input the sender's alias through the option 306. In some implementations, if the sender finishes adjusting payment transaction detail options, the sender may choose to process the payment transaction by, for example, proceeding with touch ID 308.

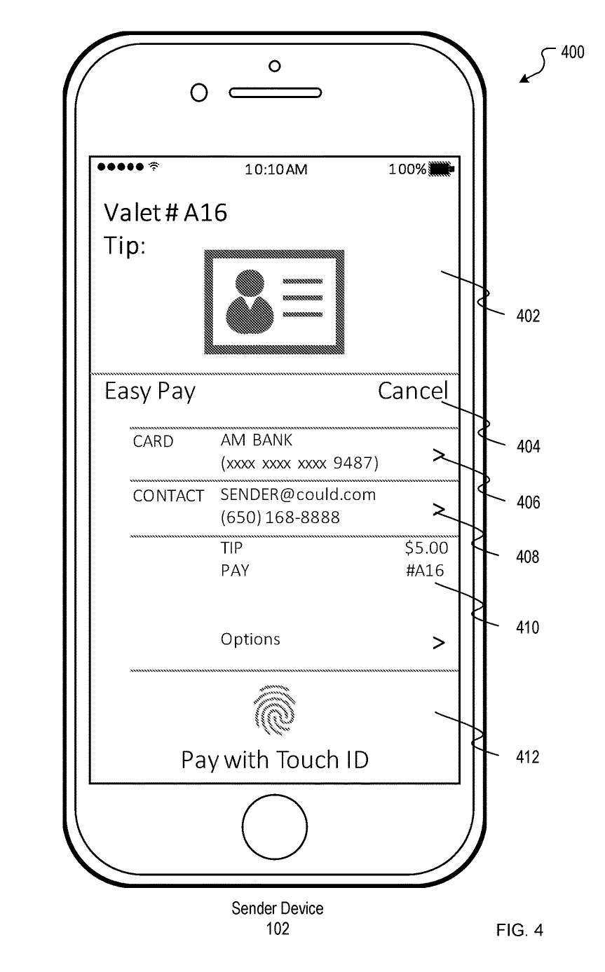

FIG. 4 illustrates an example graphical user interface 400 displaying payment options to the sender. For example, once the sender chose to process the payment in FIG. 3, user device 102 may display the payment options screen 400. In particular, FIG. 4 illustrates an example graphical user interface (i.e., payment options screen 400) for the user to use the default credit card (e.g., 406) as a default payment option that the user can change. Similar as above, to facilitate the following discussion regarding the operation of sender device 102 in conducting a payment transaction, reference is made to drawings which may be representative of possible screen shots of sender device 102 during the transaction. The functionality described may be achieved with a wide variety of graphical elements and visual schemes. Therefore, the present embodiments are not intended to be limited to the precise user interface conventions adopted herein. Rather, embodiments may include a wide variety of user interface styles.

In some implementations, graphical user interface 400 can include recipient anonymous information 402 for the sender to identify the recipient. For example, recipient anonymous information 402 can be a picture of the recipient, recipient's nickname or alias, recipient's employee number, etc. based on the preference of the recipient.

In some implementations, graphical user interface 400 can include final payment amount 410. For example, final payment amount 410 can include the purpose of the payment (e.g., to tip the valet). For example, the sender can change the payment amount by selecting or clicking graphical element options 410.

In some implementations, graphical user interface 400 can include limited sender's personal information 408 about the sender. For example, as shown in FIG. 4, the limited sender's personal information 408 about the sender includes sender's email address and sender phone number. In some implementations, the sender can change the limited sender's personal information 408 regarding the sender by selecting or clicking graphical element 408. For example, if sender does not want the recipient to know who sent the money to the recipient, sender may do so by selecting graphical element 408 and change the limited sender's personal information.

In some implementations, graphical user interface 400 can include default credit card 404. For example, sender device 102 may determine the default credit card within graphical element item 404 based on one or more previous transactions. In some implementations, the user can provide input to change default credit card and select a different card. For example, the sender can change the default credit card by selecting or clicking graphical element item 404. For example, sender device 102 may include a default credit card and a prioritized credit card listing of possible payment options that have been stored on sender device 102.

For example, from payment options screen 400, the user may authorize payment using a default or selected payment option (e.g., default credit card 404) by providing biometric input 412. For example, biometric input 412 can be a scan of a fingerprint, an image of the user's face, a retinal scan, or other type of biometric input. Sender device 102 can authenticate the user based on biometric input 412 and initiate payment of the final payment amount when the sender has been authenticated. For example, sender device 102 can then send the sender authentication credentials including the above sender's selection (e.g., card 406, contact 408, options 410, etc.) to payment processing server 112 over network 108.

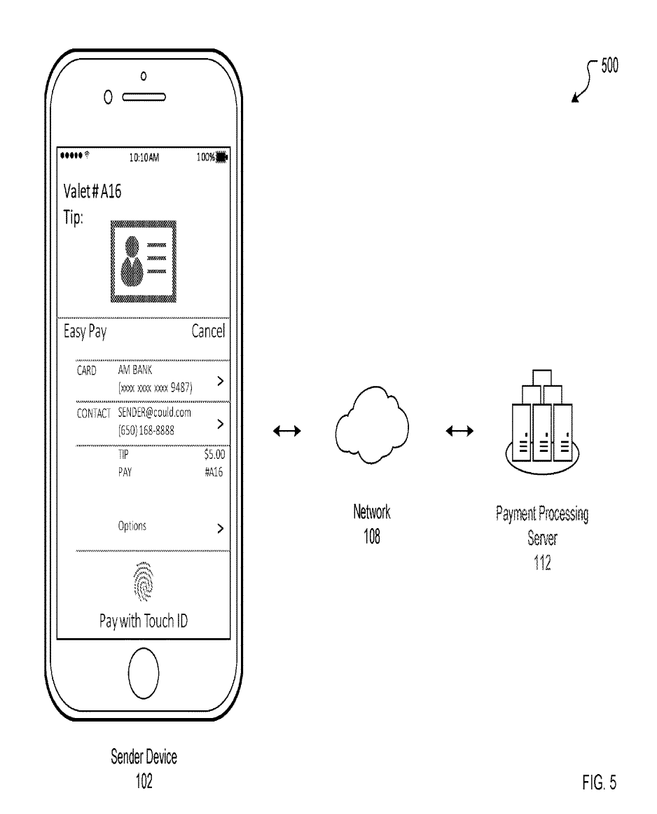

FIG. 5 is a block diagram of an example system 500 for transferring the final payment amount from the sender to the recipient. For example, as described above, payment processing server 112 can receive sender authentication credentials from sender device 102 through network 108. For example, the sender authentication credentials can include the sender payment token, the recipient payment token, the final payment amount, sender's biometric data, fingerprint etc. In some implementations, payment processing server 112 can validate the sender is authorized for the payment account based on sender authentication credentials provided by sender device 102.

As described above, in some implementations, payment processing server 112 can determine whether the payment should be transferred from sender's account to recipient's account based on sender authentication credentials provided by sender device 102. For example, once the sender authentication credentials are validated, payment processing server 112 can send a payment confirmation notification to sender device 102 indicating that payment was processed.

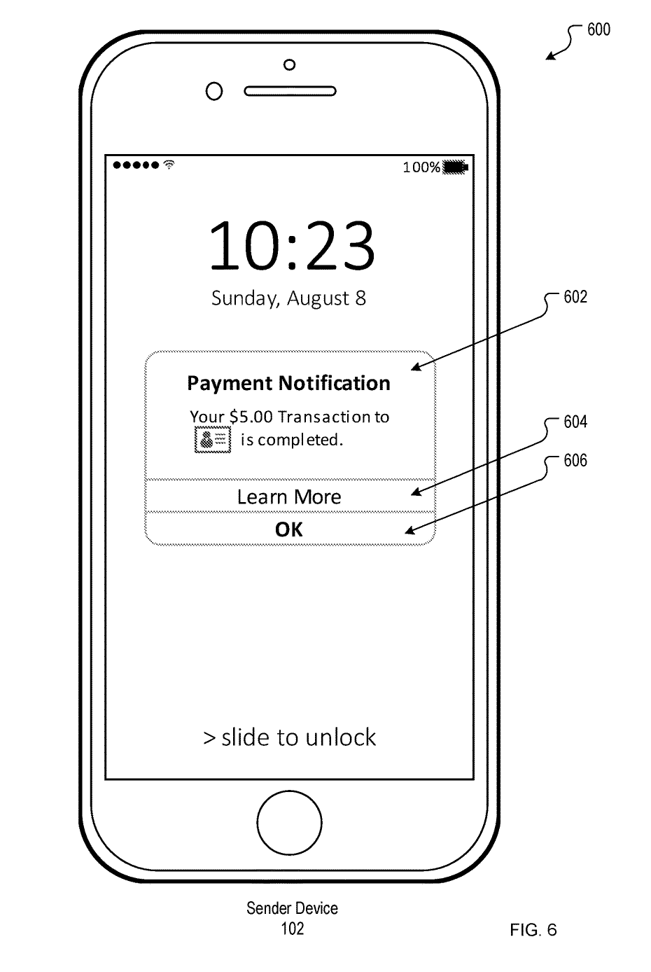

FIG. 6 illustrates an example graphical user interface 600 for displaying payment confirmation notification 602. For example, sender device 102 may receive payment confirmation notification 602 indicating that payment was processed. In some implementations, payment confirmation notification 602 may include a brief description for the payment transaction. For example, the brief description may include the recipient and the payment amount. In some implementations, user may select “learn more” item 604 within payment confirmation notification 602 to view the receipt of the payment transaction which includes more detail about the transaction. For example, the receipt may provide the final payment amount, the anonymous information of the recipient, the transaction date etc. In some implementations, the sender can select “OK” item 606 to dismiss the payment confirmation notification 602.

In some implementations, similar as above, graphical user interface 600 can present the graphical notification of payment confirmation notification 602 on sender device 102 to the user. For example, graphical user interface (GUI) 600 can be a home screen, navigational menu, or application selection user interface. For example, graphical element 602 can be an image, icon, or other graphical objects for a user to select to review the receipt.

### Example Processes

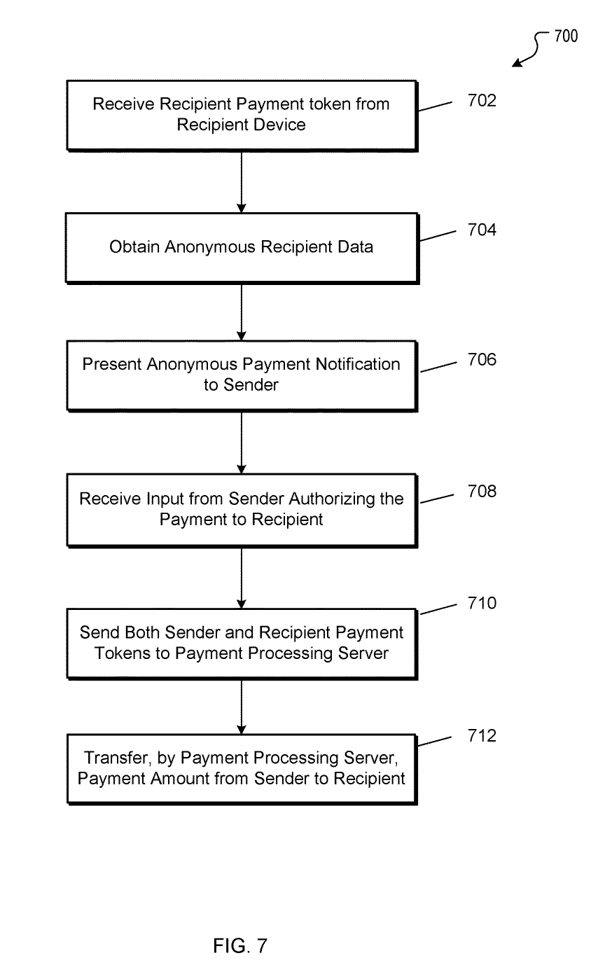

FIG. 7 is a flow diagram of an example process 700 for making anonymous payments. For example, a user device can implement process 700 to allow a sender to make anonymous direct person-to-person payments to a recipient.

At step 702, sender device 102 can receive recipient payment tokens from the recipient identification devices (e.g., 104a, 104b, mobile device). For example, the recipient mobile device can advertise a recipient payment token for an anonymous payment through peer-to-peer Wi-Fi, Bluetooth, etc. For example, recipient mobile device can advertise a recipient payment token (e.g., recipient's phone number, recipient's email, recipient's account, etc.) including an identifier for recipient's payment account registered with a payment processing server.

In some implementations, system 100 can include recipient identification device 104a/104b. For example, recipient identification device 104a/104b can correspond to a QR label, NFC chip/RFID embedded in an identification card, name tag, etc. that can be scanned by a payment sender's device to obtain a recipient payment token. For example, sender device 102 may include a scanner and the scanner may be used to obtain the recipient payment token associated with the recipient identifying information from a bar code, a QR code, or the like. Sender device 102 may also include a camera and the camera may be used to identify the recipient payment token associated with the recipient. One of the ordinary skill in the art will recognize various devices and techniques for implementing the bar code scanner within sender device 102. In some implementations, the camera may be used to capture an image of a bar code, or other things, which may then be processed by user device 102 to extract the encoded recipient-identifying information associated with the corresponding recipient identification device. Techniques for processing a video image to extract coded information will also be known by those of ordinary skill in the art. In some implementations, sender device 102 may include a near field communication (NFC) interface. The close range communication with the NFC interface may take place through magnetic field induction, allowing the NFC interface to communicate with other NFC devices such as radio frequency identification (RFID) tags, for example. In some implementations, the NFC interface may be used to identify a recipient identification device that contains an NFC compatible device such as an RFID tag. Therefore, sender device 102 can receive the plurality of recipient payment tokens obtained from different ways addressed above for a payment transaction.

At step 704, sender device 102 can obtain anonymous recipient data (i.e., the anonymous information) from the recipient identification devices (e.g., 104a, 104b, mobile device). In some implementations, the recipient can register recipient's accounts with a payment processing server associated with recipient's payment token. In some implementations, the recipient can configure recipient's accounts with a payment processing server to provide anonymous information (e.g., to obfuscate at least a portion of recipient's personal information or identity) to the sender. For example, the recipient's payment token can be an email address, a telephone number, a picture of the recipient, etc.

At step 706, sender device 102a can present an anonymous payment notification (i.e., the candidate recipient notification) to the sender. In some implementations, sender device 102 can obtain the recipient payment token from recipient the identification device. For example, sender device 102 can receive the recipient payment token when it is within the range of recipient identification device 104a. Thus, in some implementations, the user may move sender device 102 near recipient identification device 104a to receive the recipient payment token and initiate a transaction. In some implementations, in response to receiving the recipient payment token, sender device 102 may automatically present the recipient identifier or recipient payment token (e.g., recipient's alias, recipient's employee number, etc.) in the candidate recipient notification to the sender. Alternatively, in response to receiving the recipient payment token, sender device 102 may send the transaction package including the recipient payment token and the sender payment token to payment server 110. In some implementations, as described above, upon receiving the additional recipient anonymous information from payment server 110, sender device 112 may present the recipient identifier or additional recipient anonymous information based on the recipient's preference to the sender. In some implementations, sender device 102 can only receive the recipient payment token when it is within the range of recipient identification device 104a. Thus, the user may move user device 102 near recipient identification device 104a to receive the recipient payment token.

For example, the recipient anonymous information can include the picture of recipient, recipient's nickname or alias (e.g., Emily), recipient's employee number (e.g., B18), etc. based on the preference of the recipient. In some implementations, the recipient can set up or change the preference with payment server 110 as described above. For example, if the valet wants to receive the tip from the sender and hope the sender can recognize the valet by the alias of the valet, the valet can provide his/her alias to payment server 110. For example, if later valet wants to receive the tip from the sender and hope the sender can recognize the valet by his/her picture, not the valet's alias, the valet can change his/her preference with payment server 110 by removing his/her alias and adding his/her picture.

At step 708, sender device 102 can receive input from the sender authorizing a payment to the recipient. For example, in response to receiving an anonymous payment notification (i.e., candidate recipient notification 210) at step 706, sender device 102 can present a payment prompted on a display of sender device 102. When the sender authorizes payment of the final payment amount (e.g., through biometric input, by providing credentials, etc.), sender device 102 can send the sender authentication credentials to payment processing server 112 over network 108 so that the payment to the recipient can be processed. For example, the sender authentication credentials can include the sender payment token, the recipient payment token, the final payment amount, sender's biometric data, fingerprint etc.

At step 710, sender device 102 can send the recipient payment token and the sender payment token to payment processing server 112. For example, in response to receiving the selection of the candidate recipient notification, sender device 102 may send the sender authentication credentials to payment processing server 112. In some implementations, the sender authentication credentials can include sender payment token, the recipient payment token, the final payment amount, sender's biometric data, fingerprint etc.

At step 712, payment processing server 112 can transfer the payment amount from the sender to the recipient. As described above, in some implementations, payment processing server 112 can determine whether the payment should be transferred from sender's account to recipient's account based on sender authentication credentials provided by sender device 102. For example, once the sender authentication credentials are validated, payment processing server 112 can send a payment confirmation notification to sender device 102 indicating that payment was processed. In some implementations, once the payment transaction is complete, payment processing server 112 can send a payment completed notification (e.g., recipient's receipt) to the recipient's device (e.g., recipient mobile device). In some implementations, the payment completed notification may include a brief description for the payment transaction. For example, the brief description may include the sender and the payment amount. In some implementations, user may select the payment completed notification to view more detail about the transaction. For example, the receipt may provide the final payment amount, the anonymous information of the sender, the transaction date etc.

### Graphical User Interfaces

This disclosure above describes various Graphical User Interfaces (GUIs) for implementing various features, processes or workflows. These GUIs can be presented on a variety of electronic devices including but not limited to laptop computers, desktop computers, computer terminals, television systems, tablet computers, e-book readers and smart phones. One or more of these electronic devices can include a touch-sensitive surface. The touch-sensitive surface can process multiple simultaneous points of input, including processing data related to the pressure, degree or position of each point of input. Such processing can facilitate gestures with multiple fingers, including pinching and swiping.

When the disclosure refers to “select” or “selecting” user interface elements in a GUI, these terms are understood to include clicking or “hovering” with a mouse or other input device over a user interface element, or touching, tapping or gesturing with one or more fingers or stylus on a user interface element. User interface elements can be virtual buttons, menus, selectors, switches, sliders, scrubbers, knobs, thumbnails, links, icons, radio buttons, checkboxes and any other mechanism for receiving input from, or providing feedback to a user.

### Privacy

The present disclosure recognizes that the use of such personal information data, in the present technology, can be used to the benefit of users. For example, the personal information data can be used to deliver targeted content that is of greater interest to the user. Accordingly, use of such personal information data enables calculated control of the delivered content. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services. In another example, users can select not to provide location information for targeted content delivery services. In yet another example, users can select to not provide precise location information, but permit the transfer of location zone information.

### Example System Architecture

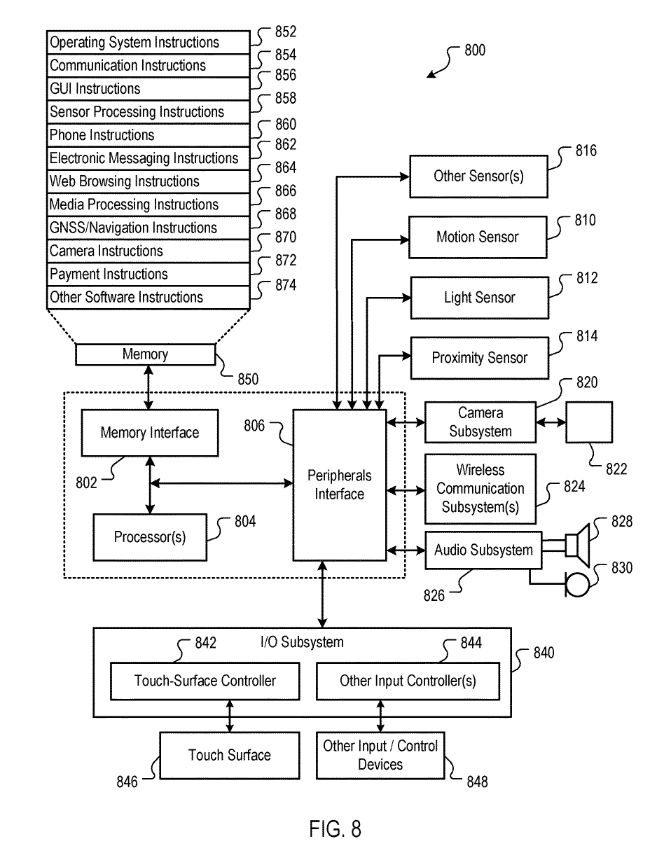

FIG. 8 is a block diagram of an example computing device 800 that can implement the features and processes of FIGS. 1-7. The computing device 800 can include a memory interface 802, one or more data processors, image processors and/or central processing units 804, and a peripherals interface 806. The memory interface 802, the one or more processors 804 and/or the peripherals interface 806 can be separate components or can be integrated in one or more integrated circuits. The various components in the computing device 800 can be coupled by one or more communication buses or signal lines.

Sensors, devices, and subsystems can be coupled to the peripherals interface 806 to facilitate multiple functionalities. For example, a motion sensor 810, a light sensor 812, and a proximity sensor 814 can be coupled to the peripherals interface 806 to facilitate orientation, lighting, and proximity functions. Other sensors 816 can also be connected to the peripherals interface 806, such as a global navigation satellite system (GNSS) (e.g., GPS receiver), a temperature sensor, a biometric sensor, magnetometer or other sensing device, to facilitate related functionalities.

A camera subsystem 820 and an optical sensor 822, e.g., a charged coupled device (CCD) or a complementary metal-oxide semiconductor (CMOS) optical sensor, can be utilized to facilitate camera functions, such as recording photographs and video clips. The camera subsystem 820 and the optical sensor 822 can be used to collect images of a user to be used during authentication of a user, e.g., by performing facial recognition analysis or scanning bar codes, etc.

Communication functions can be facilitated through one or more wireless communication subsystems 824, which can include radio frequency receivers and transmitters and/or optical (e.g., infrared) receivers and transmitters. The specific design and implementation of the communication subsystem 824 can depend on the communication network(s) over which the computing device 800 is intended to operate. For example, the computing device 800 can include communication subsystems 824 designed to operate over a GSM network, a GPRS network, an EDGE network, a Wi-Fi or WiMax network, and a Bluetooth™ network. In particular, the wireless communication subsystems 824 can include hosting protocols such that the device 100 can be configured as a base station for other wireless devices.

An audio subsystem 826 can be coupled to a speaker 828 and a microphone 830 to facilitate voice-enabled functions, such as speaker recognition, voice replication, digital recording, and telephony functions. The audio subsystem 826 can be configured to facilitate processing voice commands, voice printing and voice authentication, for example.

The I/O subsystem 840 can include a touch-surface controller 842 and/or other input controller(s) 844. The touch-surface controller 842 can be coupled to a touch surface 846. The touch surface 846 and touch-surface controller 842 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch surface 846.

The other input controller(s) 844 can be coupled to other input/control devices 848, such as one or more buttons, rocker switches, thumb-wheel, infrared port, USB port, and/or a pointer device such as a stylus. The one or more buttons (not shown) can include an up/down button for volume control of the speaker 828 and/or the microphone 830.

In one implementation, a pressing of the button for a first duration can disengage a lock of the touch surface 846; and a pressing of the button for a second duration that is longer than the first duration can turn power to the computing device 800 on or off. Pressing the button for a third duration can activate a voice control, or voice command, module that enables the user to speak commands into the microphone 830 to cause the device to execute the spoken command. The user can customize a functionality of one or more of the buttons. The touch surface 846 can, for example, also be used to implement virtual or soft buttons and/or a keyboard.

In some implementations, the computing device 800 can present recorded audio and/or video files, such as MP3, AAC, and MPEG files. In some implementations, the computing device 800 can include the functionality of an MP3 player, such as an iPod™. The computing device 800 can, therefore, include a 36-pin connector that is compatible with the iPod. Other input/output and control devices can also be used.

The memory interface 802 can be coupled to memory 850. The memory 850 can include high-speed random access memory and/or non-volatile memory, such as one or more magnetic disk storage devices, one or more optical storage devices, and/or flash memory (e.g., NAND, NOR). The memory 850 can store an operating system 852, such as Darwin, RTXC, LINUX, UNIX, OS X, WINDOWS, or an embedded operating system such as VxWorks.

The operating system 852 can include instructions for handling basic system services and for performing hardware dependent tasks. In some implementations, the operating system 852 can be a kernel (e.g., UNIX kernel). In some implementations, the operating system 852 can include instructions for performing voice authentication. For example, operating system 852 can implement the making anonymous payments features as described with reference to FIGS. 1-7. For example, operating system 852 can be configured to perform a person-to-person transaction between parties (e.g., a payment sender and a payment recipient) to the transaction while obfuscating at least a portion of the parties' personal information as described above.

The memory 850 can also store communication instructions 854 to facilitate communicating with one or more additional devices, one or more computers and/or one or more servers. The memory 850 can include graphical user interface instructions 856 to facilitate graphic user interface processing; sensor processing instructions 858 to facilitate sensor-related processing and functions; phone instructions 860 to facilitate phone-related processes and functions; electronic messaging instructions 862 to facilitate electronic-messaging related processes and functions; web browsing instructions 864 to facilitate web browsing-related processes and functions; media processing instructions 866 to facilitate media processing-related processes and functions; GNSS/Navigation instructions 868 to facilitate GNSS and navigation-related processes and instructions; and/or camera instructions 870 to facilitate camera-related processes and functions.

The memory 850 can store other software instructions 872 to facilitate other processes and functions, such as making anonymous payments processes and functions as described with reference to FIGS. 1-7.

The memory 850 can also store other software instructions 874, such as web video instructions to facilitate web video-related processes and functions; and/or web shopping instructions to facilitate web shopping-related processes and functions. In some implementations, the media processing instructions 866 are divided into audio processing instructions and video processing instructions to facilitate audio processing-related processes and functions and video processing-related processes and functions, respectively.

Although not depicted, device 800 can include provision of electricity via a battery, solar cells for providing electricity, motion-to-electricity converters, and/or AC/DC conversion.

Each of the above identified instructions and applications can correspond to a set of instructions for performing one or more functions described above. These instructions need not be implemented as separate software programs, procedures, or modules. The memory 850 can include additional instructions or fewer instructions. Furthermore, various functions of the computing device 800 can be implemented in hardware and/or in software, including in one or more signal processing and/or application specific integrated circuits.

What is claimed is:

1. A method comprising:
receiving, at a mobile device, a first payment token from a first device, the first payment token corresponding to a first user of the first device;
obtaining, by the mobile device, anonymous user data corresponding to the first payment token, the anonymous user data anonymously representing the first user;
presenting, by the mobile device, a notification presenting the anonymous user data and prompting second user of the mobile device to send a payment to the first user represented by the anonymous payment data;
receiving, by the mobile device, input from the second user authorizing a payment to the first user; and
sending, by the mobile device, the first payment token and a second payment token corresponding to the second user to a payment processing server, where the payment processing server uses the first payment token and the second payment token to transfer the payment from the second user to the first user.

2. The method of claim 1, wherein obtaining anonymous user data corresponding to the first payment token includes obtaining the anonymous user data from the first payment token.

3. The method of claim 1, wherein the anonymous user data includes limited personal information of the first user based on a preference of the first user.

4. The method of claim 3, wherein the limited personal information includes an image of the first user.

5. The method of claim 3, wherein the limited personal information includes a nickname of the first user.

6. The method of claim 3, wherein the limited personal information includes the employment number of the first user.

7. The method of claim 1, wherein the first device is attached to the first user.

8. The method of claim 1, further comprising:
sending an anonymous payment completed notification to the first user, wherein the anonymous payment completed notification includes the payment and limited information associated with the second user based on the input from the second user.

9. The method of claim 8, wherein the limited information includes personal contact information of the second user.

10. A system comprising:
one or more processors; and
a non-transitory computer-readable medium including one or more sequences of instructions that, when executed by one or more processors, causes:
receiving, at a mobile device, a first payment token from a first device, the first payment token corresponding to a first user of the first device;
obtaining, by the mobile device, anonymous user data corresponding to the first payment token, the anonymous user data anonymously representing the first user;
presenting, by the mobile device, a notification presenting the anonymous user data and prompting a second user of the mobile device to send a payment to the first user represented by the anonymous payment data;
receiving, by the mobile device, input from the second user authorizing a payment to the first user; and
sending, by the mobile device, the first payment token and a second payment token corresponding to the second user to a payment processing server, where the payment processing server uses the first payment token and the second payment token to transfer the payment from the second user to the first user.

11. The system of claim 10, wherein obtaining anonymous user data corresponding to the first payment token includes obtaining the anonymous user data from the first payment token.

12. The system of claim 10, wherein the anonymous user data includes limited personal information of the first user based on a preference of the first user.

13. The system of claim 12, wherein the limited personal information includes an image of the first user.

14. The system of claim 12, wherein the limited personal information includes a nickname of the first user.

15. The system of claim 12, wherein the limited personal information includes the employment number of the first user.

16. The system of claim 10, wherein the first device is attached to the first user.

17. The system of claim 10, further comprising:
sending an anonymous payment completed notification to the first user, wherein the anonymous payment completed notification includes the payment and limited information associated with the second user based on the input from the second user.

18. The system of claim 17, wherein the limited information includes personal contact information of the second user.
